(19) United States
(12) Patent Application Publication
(10) Pub. No.: US 2010/0277906 A1
(43) Pub. Date: Nov. 4, 2010

(54) LIGHT EMITTING DIODE LAMP FOR STREET LIGHTING WITH ADJUSTABLE EMISSION ANGLE

(75) Inventors: Jong-kyun CHOI, Kyunggi-do (KR); Wang-gun YU, Seoul (KR); Taek-young KIM, Kwangju City (KR)

Correspondence Address: HOLLAND & KNIGHT LLP, 2099 PENNSYLVANIA AVE, SUITE 100, WASHINGTON, DC, 20006, US

(73) Assignee: LED FOLIO CORPORATION, Riverdale, NJ (US)

(21) Appl. No.: 12/543,818

(22) Filed: Aug. 19, 2009

(30) Foreign Application Priority Data
May 4, 2009 (KR) 10-2009-0039025

(51) Int. Cl. F21V 1/00

(52) U.S. Cl. 362/235; 362/294

(57) ABSTRACT

A light emitting diode (LED) lamp for street lighting includes: a curved lamp cover; a lamp case coupled to the lamp cover at one open end thereof and having an inner space in which a drive module for driving the lamp and a plurality of LED modules as light sources are mounted; and a reflective plate fastened to the lamp case to reflect light from the LED modules installed in the lamp case, wherein the lamp case is divided into a first housing portion having a hollow space in which the drive module is fixedly installed and a second housing portion in which a mounting member configured to mount the LED modules thereon is installed, and wherein direction adjusting members are respectively inserted between the mounting member and at least one of the LED modules in the second housing portion and each having a lower joining surface and an upper joining surface, the lower joining surface being flat such that the direction adjusting member contacts the mounting member and the upper joining surface being flat such that a printed circuit board substrate of the LED module is on the direction adjusting member, the upper and lower joining surfaces being not parallel to each other but forming a predetermined angle.

This invention claims the benefit of Korean Patent Application No. 10-2009-0039025 filed in Korea on May 4, 2009, which is hereby incorporated by reference in its entirety.

### BACKGROUND OF THE INVENTION

1. Field of the Invention

The invention relates to a light emitting diode (hereinafter, abbreviated as “LED”) lamp for street lighting whose emission angle is adjustable, and more particularly to an LED lamp for street lighting constructed such that the emission angle of light from a plurality of LED modules can be controlled.

2. Description of the Related Art

Generally, street lamps refer to lighting systems that are installed along sidewalks or roadways in order to illuminate the streets and ensure traffic safety. A typical street lamp includes a light source, such as a mercury lamp, a fluorescent lamp or a sodium lamp, a lighting fixture for mounting the light source thereon, a power supply unit for supplying power to the light source, a timer, and a central control unit operated to turn the light source on and off. Such a street lamp is designed to illuminate the surrounding area above a predetermined illuminance.

In recent years, LEDs have been widely applied as light sources of street lamps for their low power consumption, semi-permanent lifetime and improved illuminance. Regulatory guidelines for the installation of street lamps have been established. As illustrated in FIG. 1, when a street lamp 1 is 10 m high from the ground, the illuminance values measured at ground positions B and C 10 m apart from ground position A where the street lamp is installed should be as high as 20 Lux.

LEDs are advantageous in terms of power consumption and luminance when compared to other light sources. However, since light from LEDs rectilinearly propagates in limited directions in view of the structural characteristics of the LEDs, there is difficulty in illuminating areas apart from a street lamp employing the LEDs. Further, since LED lamps for street lighting emit light of a single color inherent to the LEDs, walkers and drivers feel monotonous and tired.

### SUMMARY OF THE INVENTION

Embodiments of the invention solve the problems of the prior art, and provide a light emitting diode (LED) lamp for street lighting which includes: a curved lamp cover; a lamp case coupled to the lamp cover at one open end thereof and having an inner space in which a drive module for driving the lamp and a plurality of LED modules as light sources are mounted; and a reflective plate fastened to the lamp case to reflect light from the LED modules installed in the lamp case, wherein the lamp case is divided into a first housing portion having a hollow space in which the drive module is fixedly installed and a second housing portion in which a mounting member configured to mount the LED modules thereon is installed, and wherein a direction adjusting member is inserted between the mounting member and each of the LED modules in the second housing portion and has a lower joining surface and an upper joining surface, the lower joining surface contacts the mounting member and the upper joining surface being flat such that a printed circuit board (PCB) substrate of the LED module is on the direction adjusting member, the upper and lower joining surfaces being not parallel to each other but forming a predetermined angle (α2).

In one embodiment, the outer surface of the mounting member is constituted by a heat-dissipating plate having a plurality of heat-dissipating fins.

In another embodiment, the mounting member, the heat-dissipating plate and the direction adjusting members are made of aluminum.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram for explaining the illuminance of a street lamp in lateral directions;

FIG. 2 is an exploded perspective view of an LED lamp for street lighting according to an embodiment of the invention;

FIG. 3 is a block diagram of a drive module of the LED lamp of FIG. 2;

FIG. 4 is a cross-sectional view illustrating a channel-shaped mounting member of the LED lamp of FIG. 2;

FIG. 5 is a diagram for explaining the irradiation directions of light by the channel-shaped mounting member of FIG. 4;

FIG. 6 is a cross-sectional view illustrating the constitution of an LED module of the LED lamp of FIG. 2;

FIG. 7 is a perspective view illustrating a direction adjusting member of the LED lamp of FIG. 2;

FIG. 8 is a view for explaining a state in which direction adjusting members are applied to the LED lamp of FIG. 2;

FIG. 9 is a view for explaining a state in which a color film is applied to the LED lamp of FIG. 2; and

FIG. 10 is a perspective view for explaining a state in which heat-dissipating fins of a heat-dissipating plate are arranged in the LED lamp of FIG. 2.

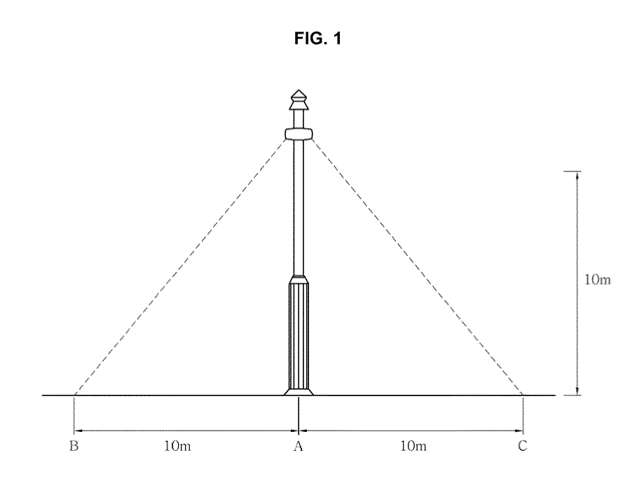

### DETAILED DESCRIPTION OF THE PREFERRED EMBODIMENTS

Exemplary embodiments of the invention will now be described with reference to the accompanying drawings.

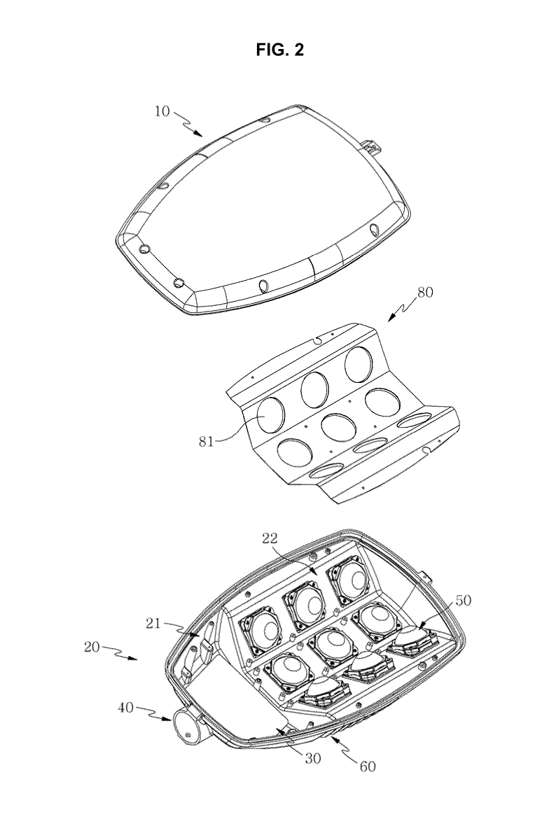

FIG. 2 is an exploded perspective view of an LED lamp for street lighting according to an embodiment of the invention. As illustrated in FIG. 2, the LED lamp includes: a transparent curved lamp cover 10 through which light is able to pass; a lamp case 20 coupled to the lamp cover 10, accommodating a drive module 30 configured to drive the lamp and a plurality of LED modules 50 as light sources. The lamp case 20 is provided with a power cable port 40 through which external power is supplied to the LED modules 50 at one side thereof. A reflective plate 80 fastened to the lamp case 20 to reflect light from the LED modules 50 installed in the lamp case 20.

The lamp cover 10 is made of glass or a transparent resin through which light from the LED modules is transmitted outside the LED lamp. Each of the lamp cover 10 and the lamp case 20 has fastening holes formed at positions facing each other through which suitable fastening members, such as bolts and nuts, are assembled with each other.

The lamp case 20 has an inner space accommodating the drive module 30 and the LED modules 50 therein and is opened at one end thereof. The lamp case 20 is curved and has a first housing portion 21. The first housing portion 21 has a hollow space in which the drive module 30 is fixedly installed to supply power to the LED modules 50 and to drive the LED modules.

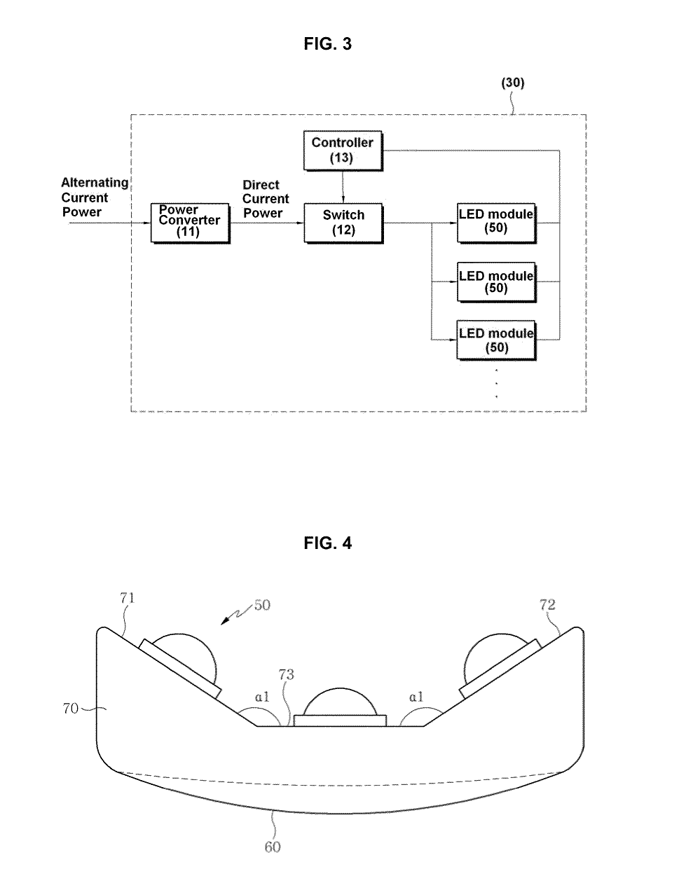

FIG. 3 is a block diagram of the drive module 30 of the LED lamp. Hereinafter, an explanation will be given with regard to the drive module 30 with reference to FIG. 3. An external power cable is introduced into the LED lamp through the power cable port 40. Alternating current power is delivered through the power cable and passes through an internal power converter 11 to be converted to direct current power. The internal power converter 11 includes a line filter, a bridge diode and other components for conversion. The direct current power is switched by a switch 12 and is then supplied to the LED modules 50. The current loading state of the LED modules 50 is checked by a controller 13 to vary the resonant frequency of the switch 12, so that the driving of the LED lamp can be stabilized by feedback control.

A plurality of LED module groups, each of which consists of two or more of the LED modules 50 combined in series, are connected in parallel to each other.

The lamp case 20 is curved and has a second housing portion 22 accommodating a channel-shaped mounting member 70, on which the LED modules 50 are seated, unlike the first housing portion 21 having a hollow space. The channel-shaped mounting member 70 has two bends so as to have a channel shape. That is, the inner surface of the channel-shaped mounting member 70 is divided into three areas.

FIG. 4 is a cross-sectional view illustrating the channel-shaped mounting member 70 of the LED lamp. Referring to FIG. 4, the channel-shaped mounting member 70 has a central area 73, a first side area 71 and a second side area 72. The first and second side areas 71 and 72 are formed at the left and right sides of the central area 73, respectively. The first and second side areas 71 and 72 are inclined with respect to the central area 73. The central area 73 is positioned parallel to the ground such that light from the LED modules 50 is directed toward the ground. The first side area 71 is inclined at an angle of 90° or greater with respect to the central area 73. The second side area 72 is inclined at an angle of 90° or greater with respect to the central area 73.

The LED modules 50 are installed on the central area 73 and the side areas 71 and 72 inclined relative to the central area 73. This inclination of the side areas 71 and 72 allows rectilinearly propagating light from the LED modules 50 to be dispersed in lateral directions. The bending angles (α1) of the first and second side areas 71 and 72 relative to the central area 73 can be in the range of 120° to 150°.

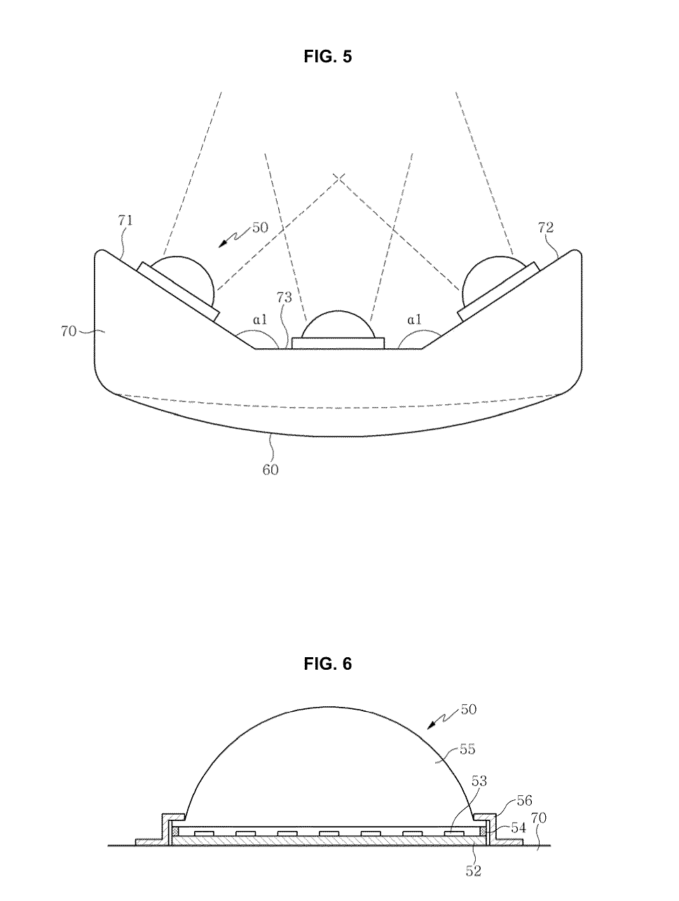

FIG. 5 illustrates the irradiation directions of light by the channel-shaped mounting member of the LED lamp. As the bending angles (α1) increase, the distances at which light from the LED light sources can arrive in lateral directions increase, but the light rays tend to interfere with one another in view of the structure of the channel-shaped mounting member. Meanwhile, as the bending angles (α1) decrease, the distances at which light from the LED light sources can arrive in lateral directions decrease. The bending angles (α1) may vary depending on how high the LED lamp is installed and how far light from the LED lamp is irradiated on the ground.

The three areas, i.e. the central area 73 and the side areas 71 and 72, on which the LED modules 50 are mounted, constitute the inner surfaces of the channel-shaped mounting member 70, and a heat-dissipating plate 60 constitutes the outer surface of the channel-shaped mounting member 70. The heat-dissipating plate 60 is configured to transfer and disperse heat generated during the on/off operation of the light sources. The heat-dissipating plate 60 absorbs and dissipates heat generated when the light sources are turned on/off and has a plurality of heat-dissipating fins 61 to increase the surface area thereof. Preferably, the heat-dissipating plate 60 and the channel-shaped mounting member 70 are made of aluminum. Formed aluminum with increased surface area can be used to increase heat dissipating efficiency.

As illustrated in FIG. 10, the heat-dissipating fins 61 of the heat-dissipating plate 60 constituting the outer surface of the channel-shaped mounting member 70 are arranged parallel to the widthwise direction of the LED lamp. A conventional LED lamp includes a plurality of heat-dissipating fins arranged along the lengthwise direction of the LED lamp. The conventional LED lamp is constructed such that a head portion having the heat-dissipating fins is approximately 10° higher than a tail portion having a power cable port. Due to this construction, rainwater drainage channels defined by the adjacent heat-dissipating fins are inclined at an angle as low as 10°, and therefore, it is difficult to drain rainwater through the rainwater drainage channels. Accordingly, foreign materials are accumulated in the rainwater drainage channels, resulting in a deterioration in the heat dissipation performance of the conventional LED lamp. In contrast, the heat-dissipating fins 61 of embodiments of the invention are arranged parallel to the widthwise direction of the LED lamp. This arrangement increases the slope of rainwater drainage channels defined by the heat-dissipating fins 61 on the back surface of the curved case to allow rainwater to easily fall down through the rainwater drainage channels.

FIG. 6 is a cross-sectional view illustrating the constitution of one of the LED modules 50 of the LED lamp. Hereinafter, the structure of the LED modules 50 mounted on the channel-shaped mounting member 70 will be explained with reference to FIG. 6. As illustrated in FIG. 6, each of the LED modules 50 includes a printed circuit board (PCB) substrate 52 that transfers heat to the channel-shaped mounting member 70 using thermal grease and a plurality of LED devices 53 mounted on the PCB substrate 52. The PCB substrate 52 serves to supply power switched by the switch 12 to the LED devices 53.

A lens 55 is seated on the PCB substrate 52 to diffuse light from the LED devices 53. A plastic-made spacer ring 54 is inserted between the PCB substrate 52 and the lens 55 to ensure the installation height of the LED devices 53. One side of a lens fixing member 56 is fixed to the lower circumferential edge of the lens 55 and the other side thereof is fixed to the channel-shaped mounting member 70. Due to this construction, the lens 55 covers the LED devices 53 to diffuse light from the LED devices 53 while maintaining its fixed position. The lens fixing member 56 is fixed to the lens 55 and the channel-shaped mounting member 70 by suitable fastening members, such as bolts. A direction adjusting member 51 is provided between the channel-shaped mounting member 70 and each of the LED modules 50 to freely control the irradiation angle of light from the LED module 50 according to the regulatory guidelines for the installation height and irradiation range of street lamps.

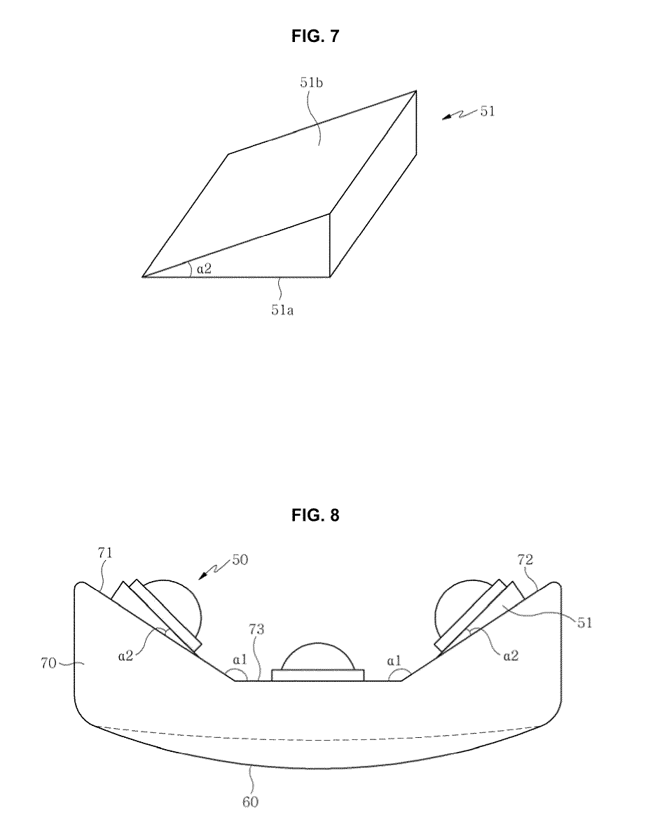

FIG. 7 is a perspective view illustrating one of the direction adjusting members 51 of the LED lamp. Referring to FIG. 7, the direction adjusting member 51 has a lower joining surface 51a and an upper joining surface 51b. The lower joining surface 51a is flat such that the direction adjusting member 51 can be brought into close contact with the first or second side area 71 or 72 of the channel-shaped mounting member 70. The upper joining surface 51b is flat such that the PCB substrate 52 of the corresponding LED module 50 can be placed on the direction adjusting member 51. The joining surfaces 51a and 51b of the direction adjusting members 51 are not parallel to each other but form a predetermined angle (α2).

As illustrated in FIG. 8, the channel-shaped mounting member 70 and the LED modules 50 are arranged at the predetermined angle (α2) relative to the respective direction adjusting members 51. With this arrangement, the irradiation angle of light from the LED modules 50 installed on the first or second side area 71 or 72 can be freely controlled by varying the angle (α2) of the direction adjusting members 51. The angle (α2) between the first and second joining surfaces 51a and 51b of the direction adjusting members 51 may be in the range of 5° to 80°.

As the angle (α2) decreases, the distances at which light from the LED light sources can arrive in lateral directions increase but the light rays tend to interfere with one another in view of the structure of the direction adjusting members 51. Meanwhile, as the angle (α2) increases, the distances at which light from the LED light sources can arrive in lateral directions decrease.

The direction adjusting members 51 may be additionally installed in an as-installed street lamp product taking into consideration the installation height of the street lamp and the ground area where light from the LED lamp is irradiated. The direction adjusting members 51 and the channel-shaped mounting member 70 joined thereto are made of aluminum to maintain the heat dissipating efficiency of the LED lamp. The reflective plate 80 is interposed between the lamp cover 10 and the second housing portion 21 of the lamp case 20 to reflect light from the LED modules 50.

Referring back to FIG. 2, the reflective plate 80 has a structure corresponding to the channel-shaped mounting member 70. That is, the reflective plate 80 has two bends to form three divided areas, like the channel-shaped mounting member 70. The divided areas of the reflective plate 80 are closely coupled to the corresponding areas (i.e. the central area 73 and the first and second side areas 71 and 72) of the channel-shaped mounting member 70 to cover the channel-shaped mounting member 70 as a whole. The reflective plate 80 has lens holes 81 through which the lenses 55 of the LED modules 50 protrude and light from the LED modules 50 passes.

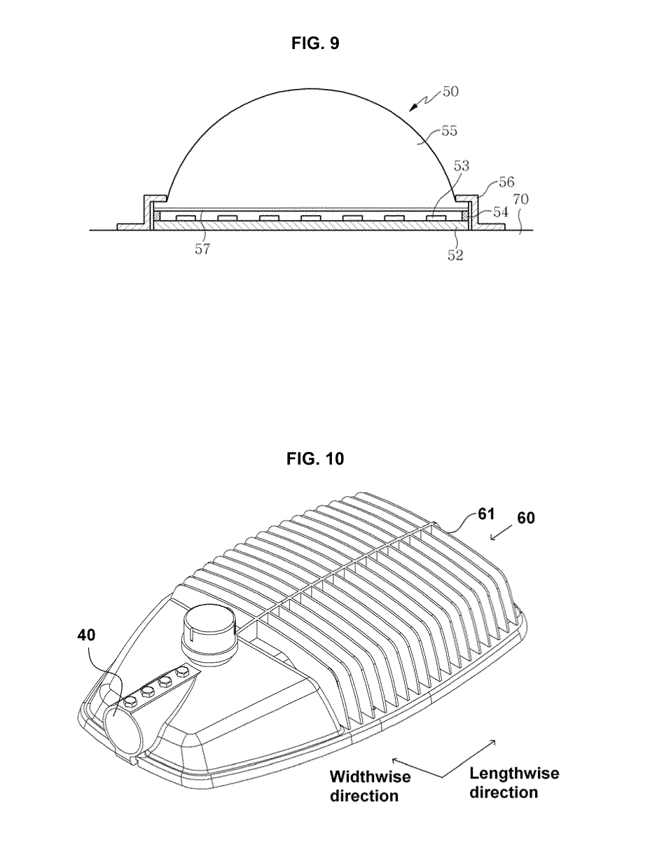

The LED lamp emits white or blue light, and in some cases, pale yellow or blue light is required depending on the installation environment. As illustrated in FIG. 9, a color film 57 may be bonded to the flat lower surface of the lens 55 facing the LED devices 53 to change the color of light from the LED modules 50 to a desired one depending on the color of the color film 57. The position of the color film 57 is not limited to the lower surface of the lens 55. For example, the color film 57 may be bonded to the curved outer surface of the lens 55. Alternatively, the color film 57 may be bonded to the inner or outer surface of the lamp cover 10.

As is apparent from the above description, the LED module mounting member is bent twice so as to have a channel shape as a whole. Due to this structure, the irradiation range of light from the LED lamp can be extended and the illuminance of the light in lateral directions of the LED lamp can be increased. In addition, the irradiation angle of light from the LED lamp can be freely changed by varying the installation angle of the direction adjusting members in order to satisfy the regulatory guidelines for the installation height and irradiation range of street lamps. Further, a color film can be inserted within the LED lamp to vary the color of light from the LED lamp. Therefore, the LED lamp can provide light of a color suitable for a particular location.

Although the invention has been described herein with reference to the foregoing embodiments and the accompanying drawings, those skilled in the art will appreciate that various substitutions, modifications and changes are possible, without departing from the spirit of the invention is not to be construed as being limited to the herein disclosed embodiments and drawings.

What is claimed is:

1. A light emitting diode (LED) lamp for street lighting, comprising:
a curved lamp cover;
a lamp case coupled to the lamp cover at one open end thereof and having an inner space in which a drive module for driving the lamp and a plurality of LED modules as light sources are mounted; and
a reflective plate fastened to the lamp case to reflect light from the LED modules installed in the lamp case,
wherein the lamp case is divided into a first housing portion having a hollow space in which the drive module is fixedly installed and a second housing portion in which a mounting member configured to mount the LED modules thereon is installed, and wherein direction adjusting members are respectively inserted between the mounting member and at least one of the LED modules in the second housing portion and each having a lower joining surface and an upper joining surface, the lower joining surface being flat such that the direction adjusting member contacts the mounting member and the upper joining surface being flat such that a printed circuit board substrate of the LED module is on the direction adjusting member, the upper and lower joining surfaces being not parallel to each other but forming a predetermined angle.

2. The LED lamp of claim 1, wherein the outer surface of the mounting member is constituted by a heat-dissipating plate having a plurality of heat-dissipating fins.

3. The LED lamp of claim 2, wherein the mounting member, the heat-dissipating plate and the direction adjusting members are made of aluminum.
